(19) United States
(12) Patent Application Publication
(10) Pub. No.: US 2011/0261804 A1
(43) Pub. Date: Oct. 27, 2011

(54) Method for home agent location

(75) Inventors: Stephane Antoine, Chiswick (GB); Ammad Akram, Reading (GB); Makis Kasapidis, Yokahama-shi (JP)

(73) Assignee: Panasonic Corporation, Osaka (JP)

(21) Appl. No.: 11/578,678

(22) PCT Filed: Feb. 28, 2005
(86) PCT No.: PCT/GB05/00745

§ 371 Date: Sep. 19, 2007

(30) Foreign Application Priority Data
Jun. 16, 2004 (GB) 0413517.4

(51) Int. Cl. H04B 7/216

(52) U.S. Cl. 370/342

(57) ABSTRACT

A mobile node stores information identifying a number of possible mobility registration servers so that it can select a server based on its geographical location rather than simply using its default server. Selection will depend on the type of ID data stored. If partially completed FQDNs are stored, a country code is added to see if this corresponds to a local server. Alternatively IP addresses can be stored and chosen by prefix matching with a Care-of-Address.

This invention relates to mobile communications and in particular it relates to a method for mobile nodes (MNs) running Mobile Internet Protocol version 6 (MIPv6) for locating and selecting a Home Agent (HA) nearer than its default HA to help reduce MIP control signalling latency and provide better traffic load balancing between HAs deployed by Internet Service Providers (ISPs) used by the MN.

### INTRODUCTION

In MIPv6, a MN has to register with its HA on its home network when it roams into foreign networks. This ensures the MN remains reachable by corresponding nodes (CNs) that identify the MN with an address associated with the home network. Registration with a distant HA exposes the data traffic between a CN and the MN to triangular routing when the CN does not support MIPv6. Triangular routing subsequently increases the end-to-end delay between the MN and the HA when the MN has roamed to a location distant from its HA. A high end-to-end delay in return can adversely affect the quality of real time applications running between the CN and the MN. Moreover, when the MN is configured with a single HA, it will be unable to communicate with a CN using its home address if that HA fails. Thus it is desirable to have a method that enables the MN to both dynamically discover and then select a HA nearer than its default HA on the home network. The possibility to select one HA among a list of multiple HAs provides fault tolerance in case the default HA fails and load balancing in case the default HA is overloaded.

### SUMMARY OF THE INVENTION

This invention relates to methods for a MN to select a HA nearer than its default HA by using identity data relating to a plurality of HAs (IDs) stored on the MN, as described in claim 1.
In one embodiment of our proposal, a possible HA's ID is the partial Fully Qualified Domain Name (FQDN) associated with the HA's IP address.
In other embodiments, the HA's ID can also be the IP address of the HA.

Selection of HA will depend on the type of ID data stored. If partially completed FQDNs are stored, a country code is added, obtained from gained location information, to see if this corresponds to a local server. If IP addresses are stored, one HA can be selected by longest prefix matching with the Care of Address.

The above embodiments provide instances of HA IDs but are not restrictive about the type of HA IDs. Other types of IDs might be used to fulfil the task of discovering a MN's nearest HA from a list of multiple HA IDs.

If no local HA is available, the default HA will be used. In this context “local” may simply mean closer, in a signalling sense, than the default HA.

The invention also provides a mobile node equipped to operate the methods of the invention.

### DESCRIPTION OF INVENTION

Examples of the invention will now be described with reference to the accompanying drawings in which like parts are designated like reference numerals and in which:

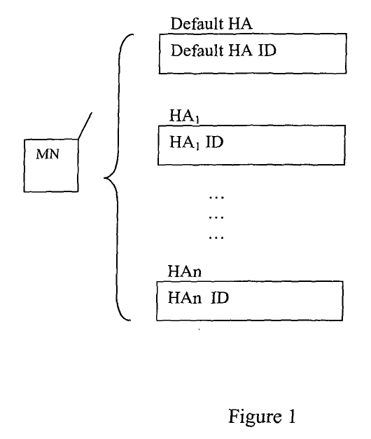

FIG. 1 schematically illustrates the list of the MN HAs' IDs.

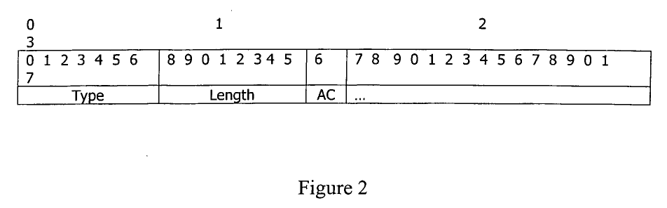

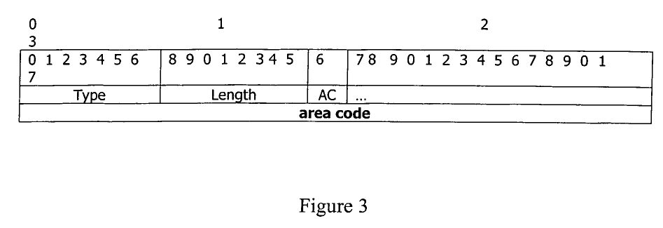

FIG. 2 and FIG. 3 show the new area code request option and the new area code option respectively.

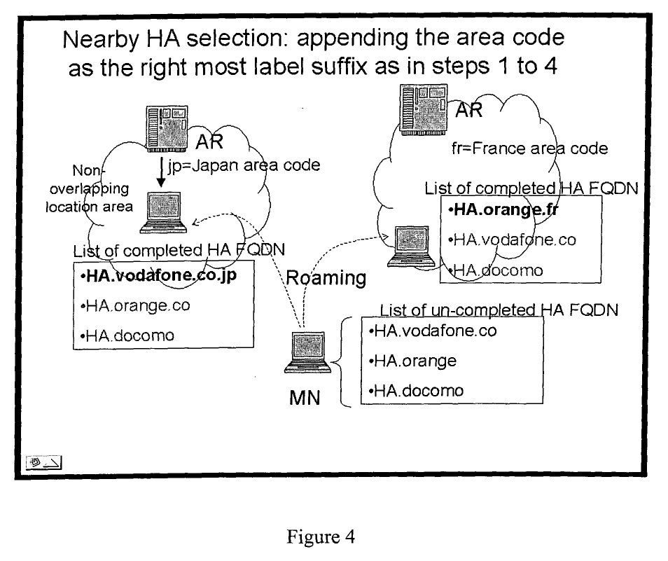

FIG. 4 illustrates schematically the selection of HA using partial FQDNs.

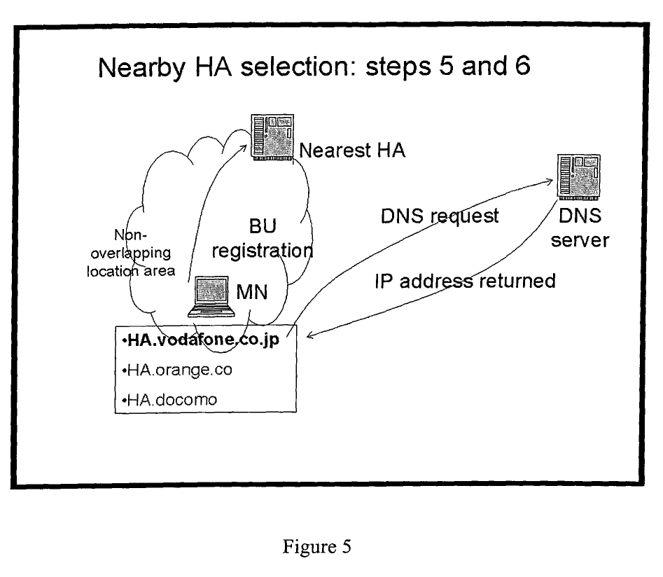

FIG. 5 illustrates the steps following on from FIG. 4 including domain name resolution.

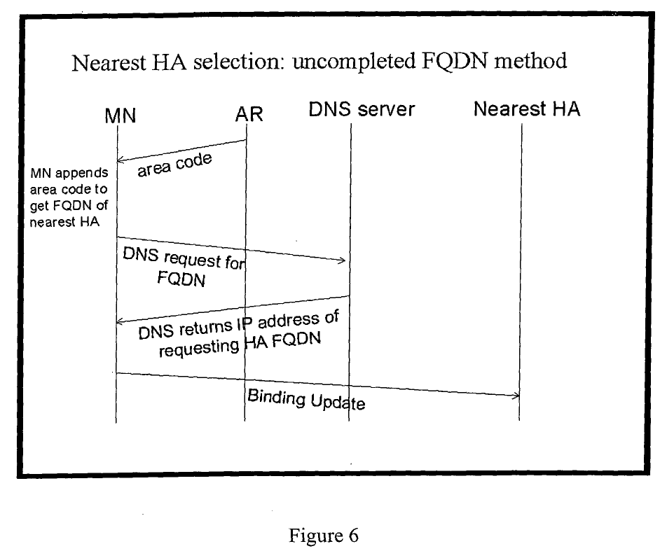

FIG. 6 is a signal flow diagram corresponding to FIGS. 4 and 5.

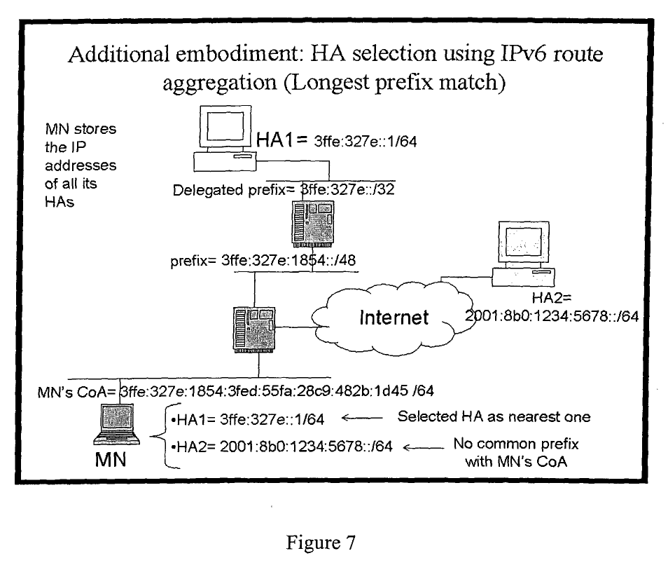

FIG. 7 illustrates schematically an embodiment of the invention using longest prefix matching between HA IP address and care of address.

Each list of HA IDs will contain a default HA ID. The default HA ID corresponds to the MN's default HA. The default HA could be a HA associated with the ISP used by the MN in its home network.

FIG. 1 illustrates a data structure of multiple HA IDs contained in the MN non-volatile memory. Note that the HAs identified by the IDs in the list of multiple HA IDs are not necessarily HAs of the same ISP. They might be HAs of several ISPs that have signed service agreements with the MN.

The insertion and deletion of HA IDs can be done by using protocols such as Simple Network Management Protocol or similar protocol depending on service agreement with ISPs and changes in network configurations.

The respective embodiments cited previously are now described in turn.

### I-1ST EMBODIMENT

In the first embodiment, the MN stores the list of its HA partial FQDNs.

In this embodiment, it is required that the fully completed FQDN of the default HA is stored as the default HA ID. For every other HA, each HA ID is the partial FQDN of that HA.

Examples of partial FQDNs are:
1. HA.vodafone.co
2. HA.orange.co
3. HA.docomo

To complete any partial FQDN, a last label that corresponds to a top-level domain label of the Domain Name System (DNS) tree is needed. The list of most Top Level-Domains currently used today can be found in [DNS and BIND”, Help for system administrators, 4^{th} edition, Oreilly, Paul Albitz & Cricket Liu, pp 553-556].

This embodiment is intended to allow the MN to retrieve the correct label that will lead to the creation of a FQDN associated with the IP address of a HA in the vicinity of the MN. To this end we propose the introduction of a new set of top-level domain labels.

### I-1 New Top-Level Domain Labels (Area Codes)

The current embodiment proposes a new set of top-level domain labels of the DNS tree. These labels will be used to identify location areas (LAs). Each top-level domain label is called an area code. Each area code will be used as the end label of registered FQDNs for IP addresses of fixed hosts or mobility agents that are located within a specific location area (LA). Thus the new set of area codes will uniquely define non-overlapping location areas around the world. The new labels will comprise two or more letters. A top-level domain label can also be an existing country code or the label for a top-level domain that is not a country.

The area codes will be attributed to ISP's administrative domains for location services purposes. In each location area, an ISP will be assigning the domain name of this location area. The size of the location area is arbitrarily defined. It could be a country size, or it could be a smaller size location area. The exact method for division of the world map into location areas and allocation of area labels does not impact on the present invention. It is simply assumed that following manual configuration; each AR within a particular location area will advertise the associated area code over its wireless interface. To this end, the invention proposes an extension of the Neighbour Discovery (ND) [RFC2461] to multicast the area code over the wireless link.

### I-2-New ND Extension

The new option contains the string of the area code of the LA where the advertising Access Router (AR) is located. The extension may appear in any router advertisement. It can be sent when solicited by a MN or it can be sent with an un-solicited Router advertisement.

### I-2-1 New Area Code Request Option

A MN that powers up or is attaching to a new link may request the area code of its serving AR. A new option is proposed in the router solicitation to solicit the area code of the LA in which the AR is located.

The new option is proposed as in FIG. 2. Its fields are described as follows:

Type 8-bit identifier of the area code option.

Length 8-bit unsigned integer. The length of the option (including the type and length fields) in units of 8 octets. The value 0 is invalid. Nodes must silently discard an ND packet that contains an option with length zero.

Bit AC: This bit indicates that the sender is expecting the area code of the recipient.

Each area code request option from the MN should return an area code option from the AR.

I-2-2 New area Code Option

An area code option can be included in a router advertisement. The format of an area code option is presented in FIG. 3 with the following fields:

Type 8-bit identifier of the area code option.

Length 8-bit unsigned integer. The length of the option (including the type and length fields) in units of 8 octets. The value 0 is invalid. Nodes must silently discard a ND packet that contains an option with length zero.

Bit AC: When the AC bit is set, the sender informs the recipient of the option that the option is containing the area code of the advertising AR.

Area code: It is the area code of the LA in which the advertising AR is located.

Using the above ND mechanism, the MN is able to retrieve the area code associated with the Location Area of its serving AR. For the roaming scenario, when the MN starts up in a foreign network, it can request an area code to locate a nearby HA. Locating the nearest HA is useful when the MN starts up in a country that is far away from its default home network. The following describes a method by which a MN may select a nearby HA.

I-3 Nearby HA selection

The selection process for locating a nearby HA has the steps described below. These are illustrated in the schematic diagrams of FIGS. 4 and 5 and the signal flow shown in FIG. 6.
1. At start up, the MN receives an area code from the router advertisement sent by access router AR.
2. The MN selects an ISP according to preferential settings, e.g., based on cost, availability etc. (FIG. 4 shows Vodafone preferred for Japan and Orange preferred for France.)
3. The MN then chooses the uncompleted FQDN associated with that ISP.
4. The MN appends the area code discovered as the right most label suffix of the partial FQDN.
5. DNS resolution via the DNS server returns the IP address of the HA in the Location Area (see FIGS. 5 and 6).
6. MN uses DNS returned IP address to undertake MIP registration, beginning with sending a binding update message to the chosen home agent (see FIGS. 5 and 6).
7. If appending the area code as the suffix of the partial FQDN fails to render the FQDN of a HA (e.g., DNS error), the MN reverts to registering with its default HA.

To considerably increase the likelihood for a MN to succeed in forming the FQDN of a HA after appending the DNS Area Code to the uncompleted FQDN, the following restrictions are required:

### I-4 Conventions for HA DNS Names

ISPs must have a FQDN for each of their HA IP address and register it with the DNS.
The FQDN associated with a HA IP address must be under the following format: “HA.operator.areacode”.
   i. “HA” is a host name of a Mobility agent such as a Home Agent name within the administrative domain of the operator.
   ii. “operator” is the name of the MN operator or the name of an operator the MN operator has agreements, with. Operator can take several fields such as: Vodafone, orange, docomo, sfr . . . .
iii. The “area code” is a new DNS top-level domain label to be defined. It could also be an existing country code such as “fr”, or “us” or “uk”. It could also be the code of an area such as the code of a state in the USA (e.g “ca.us”, “il.us”, . . . ).
The HA whose IP address has been registered in the DNS with a FQDN should ideally be within the boundary of the Location Area whose area code is the suffix of the HA registered FQDN.

### I-5 Conventions for Partial HA DNS Names

With the above requirements on HA DNS names, it is simply required that the partial FQDNs carried by the MN conform to the format HA.operator where HA and operator have been defined above.

The second embodiment Of the present invention considers the selection of a nearby HA using HA IDs based on IPv6 IP addresses.

### II-2^{nd} EMBODIMENT

In the second embodiment of this invention, the MN keeps a list of all its HA's IP addresses as opposed to partial FQDNs in non-volatile memory. The MN will compare its statelessly configured IPv6 address on the foreign network or Care of Address (CoA) with the entries in its list of HA's IPv6 addresses that includes the IPv6 address of its default HA on the home network. The selection of a nearby HA for MIP registration will comprise the steps listed below.

II-1 Nearby HA Selection from a Single CoA
From the list of its HAs (the list of the HAs includes the MN's default HA), the MN selects the HA whose global IP address prefix provides the longest match with the MN's CoA prefix. (Assuming stateless address configuration for the HA IP address, the prefix of the HA IP address has a 64-bit length).
If the part of the MN's CoA prefix matches several HA prefixes on the same length, the MN use some criteria to select one HA. Alternatively the MN can use its default HA for registering its CoA.
If the first field of the 4 hexadecimal characters in the MN's CoA address is not common to any of the HA's IP address, the default HA is used to register the MN's CoA.

The comparison to find the longest prefix match will be performed only on the global routing prefix of the IPv6 addresses, as the subnet ID part of the IPv6 address does not have any global significance. An example of this comparison is illustrated in FIG. 7.

### II-2 Nearby HA Selection in the Case of Multi-Homed MN

For the case where the MN has obtained several global CoAs locally, it is in principle possible to select multiple HAs. The MN can perform the selection of a nearby HA for each of its CoAs and subsequently register each CoA with the selected HA.

### II-3 IPv6 Route Aggregation

The second embodiment relies on route aggregation within the IPv6 Internet. Route aggregation within the IPv6 Internet will be performed in a hierarchical manner. ISPs can be considered as the highest level of the hierarchy. The ISPs will, in turn, assign address spaces from their own address spaces to delegating sites. These delegating sites will further assign address spaces derived from their own space, to other organizations. And in general, the further down in the hierarchy, a customer is from an ISP, the larger the difference between the prefix of the ISP and the customer's. As presented in RFC 3513 the global routing prefix of IPv6 addresses is designed to be structured hierarchically by the Regional Internet Registries (RIRs) and the ISPs.

### III-3^{rd} EMBODIMENT (HA Selection using TV or Radio Channels)

If equipped with TV and/or radio reception capability, the MN can select a nearby HA on the basis of location information contained within TV and/or radio broadcasts. The format of the location information is not specified in this invention but typically it could be the geographical coordinates of the broadcasting station serving that location area, or the name of the location area.

### III-2 Requirements for the Technique Proposed

The TV/radio broadcaster is required to include in its signal the geographical information of the TV/radio transmitter or information about the location area containing the TV/radio transmitter. To utilise this technique for global roaming purposes, it would be advantageous for TV/radio broadcasters to agree on a common format for providing the geographical information.

III-3 Location of a Nearby HA using TV/Radio

As in embodiments II and III, the MN carries a list of HA IDs (could be partial. FQDNs, completed FQDNs or IP addresses). But now additionally, the MN can also carry geographical information stipulating the geographical region in which each HA should be used. The geographical information obtained from TV/radio broadcasts is compared with the geographical information stored on the MN to select a nearby HA. There is also the option for the MN to translate the received TV/radio geographical information into an area code that is used (i) to complete stored partial FQDNs as in embodiment I or (ii) to select an entry from a list of completed FQDNs.

IV-4^{th} EMBODIMENT (HA Selection using Cellular Location Services and GPS)

In addition to TV/radio, the MN may be suitably equipped to obtain geographical information about its current location through alternative means such as messaging services on cellular networks, cellular location services or Global Positioning System (GPS).

A MN equipped with a cellular interface such as Global System For Mobile Communications (GSM) or Universal Mobile Telecommunications Systems (UMTS), in roaming to a new location, may receive a welcome message on a messaging service such as Short Message Service (SMS) from the new serving operator. From that SMS message, the MN could extract the location information relevant for the selection of a nearby HA as outlined in embodiment III for the TV/radio case.

Cellular location services [e.g., “Wireless location in CDMA cellular radio systems” by James J. Caffery Jr. published by Kluwer Academic Publishers 2000 (ISBN 0-7923-7703-6)] and GPS provide radiolocation-based means for a suitably equipped MN to determine its own geographical location from transmissions received from base stations and satellites respectively. In both cases, the MN uses the geographical information to select a nearby HA as outlined in embodiment III for the TV/radio case.

1. A method for selection by a roaming Mobile Node (MN) of a local mobility registration server(s) rather than its default mobility registration server(s) on the basis of acquired location information, comprising the steps of storing identity data (IDs) relating to a plurality of mobility registration servers within the MN and selecting a local mobility registration server, if available, on the basis of said identity data and said location information.

2. A method as claimed in claim 1 in which the IDs comprise one or more partial fully qualified domain names (FQDNs).

3. A method as claimed in claim 2 in which the mobile node completes a selected partial FQDN by the addition of an area code derived from said acquired location information.

4. A method as claimed in claim 2 in which the mobile node appends an area code to each entry in a list of partial FQDNs to obtain a list of completed FQDNs.

5. A method as claimed in claim 3 in which the mobile node selects a different partial FQDN or its default mobility registration server in the event of a DNS error resulting from a previously completed partial FQDN.

6. A method as claimed in claim 1 in which the IDs comprise FQDNs.

7. A method as claimed in claim 3, in which the mobile node selects a partial FQDN or a completed FQDN on the basis of predetermined criteria related to the home agents (HAs) to which the FQDNs belong.

8. A method as claimed in claim 7 in which the DNS infrastructure is used to return the IP address of the selected completed selected HA FQDN for MIP registration.

9. A method as claimed in claim 1 in which the IDs comprise IP addresses.

10. A method as claimed in claim 1 in which the location information is acquired through connection to a communications network.

11. A method as claimed in claim 10 in which the location information is acquired from a network through location area advertisement.

12. A method as claimed in claim 11 in which the location area advertisements are un-solicited.

13. A method as claimed in claim 11 in which the location area advertisements are solicited by the MN.

14. A method as claimed in claim 13 in which the MN requests location information by means of an IP location request message.

15. A method as claimed in claim 14 wherein the IP location request message is an extension to the ND Solicit message.

16. A method as claimed in claim 15 wherein the IP location request message is an optional extension to the Neighbour Discovery (ND) Solicit message.

17. A method as claimed in claim 15 wherein the location extension to the ND Solicit message comprises the fields of Type, Length and Area Code (AC) bit.

18. A method as claimed in claim 17 wherein the Type field is an 8-bit identifier of the area code option.

19. A method as claimed in claim 17 wherein the Length field is an 8-bit unsigned integer indicating the length of the entire location option in units of 8 octets.

20. A method as claimed in claim 17 wherein the AC field is a 1-bit that is set to indicate that a location area is being requested.

21. A method as claimed in claim 13 in which the network responds to the MN Solicit request with location area advertisements.

22. A method as claimed in claim 10 in which the location information is in the form of an IP location response message.

23. A method as claimed in claim 22 wherein the IP location response message is an extension to the ND Router Advertisement message.

24. A method as claimed in claim 23 wherein the location option extension to the ND Router Advertisement message comprises the fields of Type, Length, Area Code (AC) bit and Area Code.

25. A method as claimed in claim 23 wherein the Area Code field is the location area requested by the MN.

26. A method as claimed in claim 10 in which the location information is acquired from the Care of Address allocated to the MN.

27. A method as claimed in claim 9 in which the MN selects the HA whose IP address provides the longest prefix match with its current Care of Address prefix.

28. A method as claimed in claim 26 in which the MN has multiple Care of Addresses whereby it may select multiple HAs.

29. A method as claimed in claim 28 in which the MN has several MIP registrations corresponding to the several HAs.

30. A method as claimed in claim 1 in which the location information is acquired through means internal to the MN.

31. A method as claimed in claim 30 in which said means internal to the MN comprise a GPS receiver.

32. A method as claimed in claim 30 in which said means internal to the MN comprise radio location means.

33. A method as claimed in claim 1 in which the location information comprises at least one of location area codes and geographical coordinates.

34. A method as claimed in claim 28 wherein the location area codes comprise the top-level domain name codes of the regular domain name system (DNS) tree.

35. A method as claimed in claim 1 wherein the mobility registration server is a Mobile Internet Protocol (MIP) Home Agent (HA).

36. A method as claimed in claim 1 wherein the mobility registration server is a Session Initiation Protocol (SIP) registration server.

37. A method as claimed in claim 1 wherein the network includes wireless LAN equipment.

38. A method as claimed in claim 1 wherein the network comprises at least one of Television, Radio, Global System for Mobile (GSM) and Universal Mobile Telecommunications Systems (UMTS) equipments.

39. (canceled)

40. A mobile node for use in a mobile communications network comprising means for storing identity data (IDs) relating to a plurality of mobility registration servers including a default mobility registration server for the MN, means for acquiring information relating to its current location, and means for selecting a local mobility registration server in preference to its default mobility registration server on the basis of the stored identity data and acquired location information.
